(19) United States
(12) Patent Application Publication
(10) Pub. No.: US 2004/0046702 A1
(43) Pub. Date: Mar. 11, 2004

(54) Quad-band mobile radio antenna

(76) Inventor: Sheng-Gen Pan, Kamp-Lintfort (DE)

Correspondence Address: Bell, Boyd & Lloyd LLC, Three First National Plaza, Suite 3300, 70 West Madison Street, Chicago, IL, 60602-4207, US

(21) Appl. No.: 10/655,415

(22) Filed: Sep. 4, 2003

(30) Foreign Application Priority Data
Sep. 4, 2002 (EP) 02019915.4

(51) Int. Cl. H01Q 11/12

(52) U.S. Cl. 343/742; 343/867

(57) ABSTRACT

A mobile radio antenna is provided for at least four separate mobile radio standard frequency bands, which has a triband antenna A designed for three of the at least four standard frequency bands having a radio-frequency supply point S as well as at least one ground point G1 which form an input connection of the triband antenna A, and a tuned circuit S with high-pass filter characteristics connected to the input connection of the triband antenna A, which is designed such that a combination of the triband antenna A and the tuned circuit S is matched for the at least four standard frequency bands.

### BACKGROUND OF THE INVENTION

The present invention relates to a mobile radio antenna for at least four separate mobile radio standard frequency bands.

At the moment, extensive development activities are taking place on this subject in the field of mobile radio technology. These are based on the fact that the EGSM900 and PCN1800 mobile radio standard frequency bands have been defined for the European area, while the GSM850 and PCS1900 mobile radio standard frequency bands are used in the North American area. The mobile radio standard frequency bands which are used in the European area are also used in many other regions of the world.

It is desirable for manufacturers and suppliers of mobile radios to have the mobile radios equipped with mobile radio antennas which can be used throughout the world, without any further technical adaptation. This leads to a requirement for mobile radio antennas which can work in at least four separate mobile radio standard frequency bands.

So-called triband mobile radio antennas already have been introduced to the market, and support three of the mobile radio standard frequency bands mentioned above. Internal triband mobile radio antennas are arranged within a housing of the mobile radio and may be in the form of a so-called PIFA antenna. Mobile radio antennas such as these may support the EGSM900, PSC1800 and PCS1900 standard frequency bands, though they do not cover the GSM850 standard frequency band.

Against this background, the present invention is directed toward a mobile radio antenna for at least four separate mobile radio standard frequency bands, which can be produced with as little technical modification as possible to a known triband antenna.

### SUMMARY OF THE INVENTION

Accordingly, a mobile radio antenna is provided for at least four separate mobile radio standard frequency bands, which has a triband antenna which is designed for three of the at least four standard frequency bands and has a radio-frequency supply point as well as at least one ground point, which form an input connection of the triband antenna. In addition, the mobile radio antenna includes a tuned circuit with high-pass filter characteristics connected to the input connection of the triband antenna which is designed such that a combination of the triband antenna and the tuned circuit is matched for the at least four standard frequency bands.

The basic idea of the present invention is, thus, to combine a triband antenna with a tuned circuit, which is designed such that the mobile radio antenna that is created can be used for at least four separate mobile radio standard frequency bands. As such, the overall antenna structure of the mobile radio antenna is formed from a combination of a triband antenna and the tuned circuit.

This results in the advantage that mobile radios which are intended to be operated in at least four separate mobile radio standard frequency bands can, in principle, be equipped with antennas which, for example, already have been introduced to the market and for which, in particular, the tools to manufacture them are already available. The necessary retrofitting with the described tuned circuit can be regarded as a space-saving solution since the circuit for the tuned circuit can be provided on the printed circuit board which is already fitted as standard to a mobile radio.

The triband antenna is preferably an internal PIFA antenna, which is matched for the EGSM900, PCN1800 and PCS1900 standard frequency bands, and the components of the tuned circuit are chosen such that the combination of the triband antenna and the tuned circuit is matched for the ESGM900, PCN1800, PCS1900 and GSM850 standard frequency bands. In practice, the profile of a reflection coefficient of the triband antenna is modified by the use of the tuned circuit with high-pass filter characteristics such that the mobile radio antenna also can be used for GSM850.

The tuned circuit may be formed from two or more inductances and capacitances, whose values can be determined by simulation on the basis of an input impedance of the input connection of the triband antenna. It should be stressed that the design of the tuned circuit with high-pass filter characteristics is dependent, in particular, on the input impedance of the triband antenna, which is governed essentially by the physical dimensions of the triband antenna. However, there is no simpler relationship between the physical dimensions of the triband antenna and its input impedance between the radio-frequency supply point and the ground point. In consequence, it is frequently necessary either to determine the input impedance empirically or to determine it via simulation calculations.

Suitable values for the inductances and capacitances can be found empirically, based on the value determined for the input impedance, or else a linear circuit simulator is used to estimate an expected profile for the reflection coefficient of the combination of the triband antenna and tuned circuit.

Practical trials have shown that the tuned circuit with high-pass filter characteristics is preferably of the π-type. In particular, the tuned circuit may be formed from three inductances and two capacitances.

Additional features and advantages of the present invention are described in, and will be apparent from, the following Detailed Description of the Invention and the Figures.

### BRIEF DESCRIPTION OF THE INVENTION

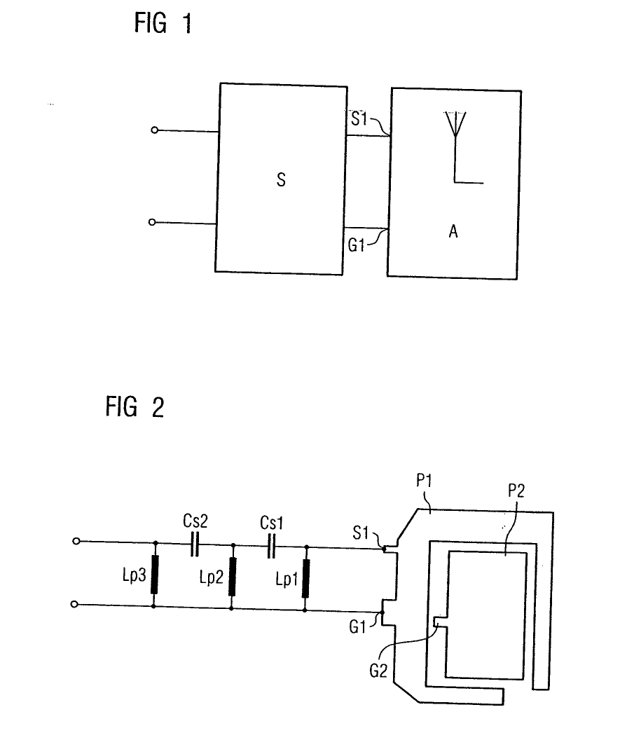

FIG. 1 shows an overview of the mobile radio antenna for at least four separate mobile radio standard frequency bands.

FIG. 2 shows an exemplary embodiment of a combination of a triband antenna and a tuned circuit with high-pass filter characteristics.

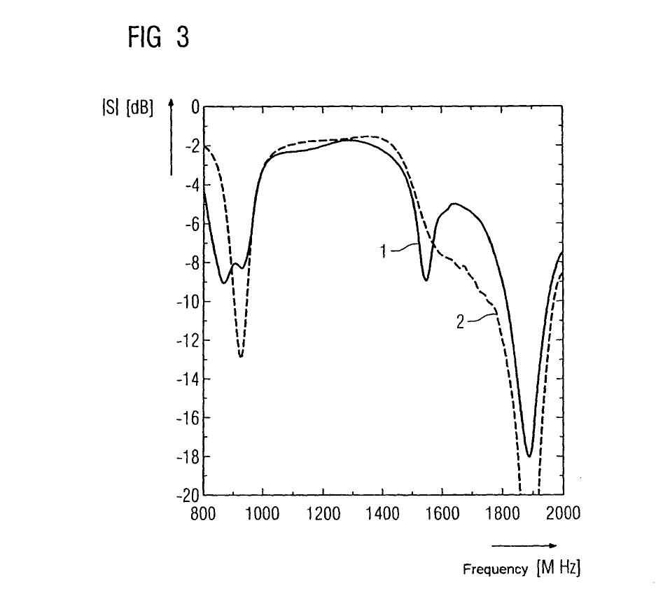

FIG. 3 shows a profile of a reflection coefficient S₁₁ for the combination shown in FIG. 2, in the frequency band between 800 and 2000 MHz.

### DETAILED DESCRIPTION OF THE INVENTION

The overview in FIG. 1 shows that an antenna for at least four separate mobile radio standard frequency bands is combined from a triband antenna A, which has an input connection with a radio-frequency supply point S1 and a ground point P1, and a tuned circuit S, which is connected to the input connection and has high-pass filter characteristics. A radio-frequency signal which originates from a transmission output stage (not shown) in a mobile radio is used as the input signal for the overall antenna structure including the tuned circuit S and the triband antenna A.

FIG. 2 shows more of the detail of the construction of one exemplary embodiment of a mobile radio antenna for at least four separate mobile radio standard frequency bands. The triband antenna A is shown on the right-hand side of FIG. 2, and this is matched for the EGSM900, PCN1800 and PCS1900 mobile radio standard frequency bands. The triband antenna A has a first antenna surface P1, which essentially describes a rectangular line that has an opening at one corner of the rectangular line, and substantially encloses a second antenna area P2. In the present embodiment of the triband antenna A, the second antenna surface P2 is also referred to as a parasitic element and is capacitively coupled to the antenna area P1. The antenna area P2 has a separate ground point G2.

The radio-frequency supply point S1 is located on one outer face of the antenna area P1; to be precise, approximately opposite the opening that is provided in the first antenna area P1.

The ground point G1 likewise is arranged on the antenna area P1. Its position is governed by the requirement for a short arm of the antenna area P1 to be provided together with the second antenna area P2, with respect to the ground point G1, for the PCN1800 and PCS1900 mobile radio standard frequency bands. In contrast, the long arm of the first antenna area P1, with respect to the ground point G1, is used for the EGSM900 standard frequency band. In this case, it should be stressed that, to be precise, the above descriptions relate to the triband antenna A being operated on its own. The interconnection of the triband antenna A to the tuned circuit S (which will now be explained) influences the profile of a reflection coefficient S₁₁.

The left-hand side of FIG. 2 shows the tuned circuit S in detail. The tuned circuit S is connected to the input connection of the triband antenna A, which is defined by the radio-frequency supply point S1 and the ground point G1. The tuned circuit S is formed from three inductances L1, Lp2, Lp3 and two capacitances Cs1, Cs2. This design corresponds to a typical circuit arrangement for a π-type high-pass filter, with the inductances Lp1, Lp2, Lp3 being interconnected on the ground side, while one of the capacitances Cs1, Cs2 is, in each case, interconnected on the radio-frequency supply point S1 side. In the present exemplary embodiment, the values of the inductances Lp1, Lp2, Lp3 may be in the range from 5 to 35 nH, while the capacitances Cs1, Cs2 may have values in the range from 1-10 pF.

Specific values for the inductances Lp1, Lp2, Lp3 and the capacitances Cs1, Cs2 are determined empirically or by simulation; to be precise, on the basis of an input impedance of the triband antenna A.

FIG. 3 shows the profile of a reflection coefficient S₁₁ (to be precise, its magnitude), as a function of the frequency between 800 and 2000 MHz. A first curve 1 relates to the combination of the triband antenna A and the tuned circuit S shown in FIG. 2 for specific values of the inductances Lp1, Lp2, Lp3 and the capacitances Cs1, Cs2 in the intervals mentioned above. Analysis of the curve 1 shows that the reflection coefficient S₁₁ has local minima at each of the EGSM900, GSM850, PCN1800 and PCS1900 standard frequency bands, so that it can be used for four separate mobile radio standard frequency bands. The reflection coefficient S₁₁ has a further minimum at about 1550 MHz, which is sufficiently pronounced that the mobile radio antenna also can be used in this frequency band, this being of practical importance for a GPS application at 1575 MHz. Overall, the combination of the triband antenna A and the tuned circuit S in fact has five local minima, which are separated from one another, for the reflection coefficient S₁₁.

For comparison purposes, the curve 2 in FIG. 3 shows a profile of the reflection coefficient S₁₁ for the triband antenna A on its own. As can be seen, the triband antenna A has a comparatively narrow minimum for the reflection coefficient S₁₁ at 900 MHz, while the curve 1 is less severely pronounced by the addition of the tuned circuit S, although a further minimum of the reflection coefficient S₁₁ is produced on the low-frequency side for the combination of the triband antenna A and the tuned circuit S. In comparison to the profile of the reflection coefficient S₁₁ for the combination, the triband antenna A on its own has a broadly pronounced minimum at about 1900 MHz, so that it also is possible to cover the mobile radio standard frequency band at 1800 MHz.

Although the present invention has been described with reference to specific embodiments, those of skill in the art will recognize that changes may be made thereto without departing from the spirit and scope of the present invention as set forth in the hereafter appended claims.

1. A mobile radio antenna for at least four separate mobile radio standard frequency bands, comprising
a triband antenna designed for three of the at least four standard frequency bands, the triband antenna including a radio-frequency supply point and at least one ground point which form an input connection of the triband antenna; and
a tuned circuit with high-pass filter characteristics connected to the input connection of the triband antenna, the tuned circuit being designed such that a combination of the triband antenna and the tuned circuit is matched for the at least four standard frequency bands.

2. A mobile radio antenna as claimed in claim 1, wherein the triband antenna is an internal PIFA antenna, which is matched for EGSM900, PCN1800 and PCS1900 standard frequency bands, and wherein components of the tuned circuit are chosen such that the combination of the triband antenna and the tuned circuit is matched for the EGSM900, PCN1800, PCS1900 and GSM850 standard frequency bands.

3. A mobile radio antenna as claimed in claim 1, wherein the tuned circuit is formed from two inductances and capacitances, whose values can be determined by simulation based on an input impedance of the input connection of the triband antenna.

4. A mobile radio antenna as claimed in claim 3, wherein the tuned circuit is of the π type.

5. A mobile radio antenna as claimed in claim 3, wherein the tuned circuit is formed from three inductances and two capacitances.
